(19) United States
(12) Patent Application Publication
(10) Pub. No.: US 2011/0238892 A1
(43) Pub. Date: Sep. 29, 2011

(54) WEAR LEVELING METHOD OF NON-VOLATILE MEMORY

(75) Inventors: Song-Feng Tsai, Hsinchu (TW); Wen-Tsung Yang, Hsinchu (TW); Jen-Yu Hsu, Hsinchu (TW)

(73) Assignee: LITE-ON IT CORP., TAIPEI CITY (TW)

(21) Appl. No.: 12/981,754

(22) Filed: Dec. 30, 2010

(30) Foreign Application Priority Data
Mar. 24, 2010 (CN) 201010145070.8

(51) Int. Cl. G06F 12/02

(52) U.S. Cl. 711/103; 711/E12.008

(57) ABSTRACT

A method of wear leveling applied to a non-volatile memory is provided. The method comprises steps of: categorizing all blocks within the non-volatile memory to a first group with erased blocks having higher history numbers, a second group with erased blocks having lower history numbers, or a third group with blocks not either assigned to the first group or the second group; selecting a first block which contains a clod data from the third group; selecting a second block from the first group; copying the cold data from the first block into the second block and updating the history number of the second block; and erasing the first block.

This application claims the benefit of People's Republic of China application Serial No. 201010145070.8, filed Mar. 24, 2010, the subject matter of which is incorporated herein by reference.

### FIELD OF THE INVENTION

The present invention relates to a wear leveling method of a non-volatile memory, and more particularly to a wear leveling method of a non-volatile memory according to the corresponding history number.

### BACKGROUND OF THE INVENTION

Typically, memory is categorized to two types, one is volatile memory and the other is non-volatile memory. The main difference between the volatile memory and the non-volatile memory is about the data stored in the memory while the power supplied to the memory is removed. That is, the data stored in the volatile memory, such as a static random access memory (SRAM) and a dynamic random access memory (DRAM), is gone after the power supplied to the volatile memory is removed. On other hand, the data stored in the non-volatile memory, such as an electrically-erasable read-only memory (EEROM) and an electrically-erasable programmable read-only memory (EEPROM), is still existed while the power supplied to the non-volatile memory is removed. However, the read/write speed of the non-volatile memory, compared with the volatile memory, is relatively low.

FIG. 1 is a block diagram of a general host system that includes a non-volatile memory device. A host system 100 (e.g., a movable flash memory device) generally includes a system bus 104, a microprocessor 108, a random access memory (RAM) 112, an input/output circuit 116 and a non-volatile memory device 120. In the host system 100, data can be transmitted between the microprocessor 108, the random access memory (RAM) 112 and the non-volatile memory device 120 through the system bus 104. The host system 100 (i.e., a movable flash memory device) can be connected to another host system (i.e., a computer system) through the input/output circuit 116.

FIG. 2 is a structure diagram of the non-volatile memory device 120. The non-volatile memory device 120 generally includes a non-volatile memory 124 and a memory controller 128. The non-volatile memory 124 includes a plurality of blocks (Block-0 to Block-N) and each of the blocks further includes a plurality of pages. Data stored in a page generally is divided to a user data and an overhead data (OH). The overhead data typically includes the information about an erase count of the corresponding page and an error correction code (ECC) that has been calculated from the corresponding user data. The memory controller 128 may calculate the ECC when data is being written into a page, and may also check the ECC when data is being read from the page.

According to the specifications of the non-volatile memory, a single page is the unit of writing data into or reading data from a non-volatile memory and a single block is the unit of erasing data from a non-volatile memory. In other words, data can be written into an individual page, data can be read from an individual page, but data in several pages belonging to the same block must be erased together. For example, data can be written to or read from the individual Page-5 of Block-1; however, the data contained in the Page-5 cannot be erased individually but must be erased along with all other pages belonging to the Block-1. Moreover, data stored in a page cannot be directly updated. For example, if the data stored in Page-5 needs updating, the updated data must be first written to a new page, and the data stored in the Page-5 is then erased later for writing the updated data.

Because the special read/write data characteristics, the non-volatile memory is not compatible to the main computer file systems (e.g., FAT16/32, NTFS). For the compatibility to the main computer file systems (e.g., FAT16/32, NTFS), a flash translation layer table (FTL Table) is introduced in the non-volatile memory system. The flash translation layer table (FTL Table) is used for mapping addresses between a logical block address (LBA) and a physical block address (PBA). That is, the logical block address (LBA) issued from the host system is first mapped to the physical block address (PBA) according to the flash translation layer table (FTL Table), and then allocated to the non-volatile memory according to the physical block address (PBA). Moreover, the flash translation layer table (FTL Table) is typically stored in the random access memory (RAM) 112, so as the accessing speed of the non-volatile memory is enhanced.

As mentioned above, the unit of erasing data from the non-volatile memory is a block. However, the number of times of each of the block can be erased is limited (e.g., a hundred thousand times) due to the physical structure of the non-volatile memory. If a block is erased more than a specific time and data cannot be correctly or completely stored in the block, the block is worn out and cannot be used anymore.

Data stored in a non-volatile memory is generally categorized to either a cold data or a hot data based on the frequency of updating. In other words, if a data (such as a system program code or a multimedia data) almost has no need to be updated, the data is often categorized to the cold data; alternatively, if a data (such as a log file) which needs frequently to be updated, the data is most likely categorized to the hot data. If clod data is always stored in specific blocks and hot data is always stored in other specific blocks, obviously the blocks always containing hot data will be worn out much earlier than the blocks always containing cold data. For an even and fair use of all the blocks within a non-volatile memory, wear leveling is introduced in the non-volatile memory. The main purpose of wear leveling is to move the cold data from a block with a fewer erase count to another block with a higher erase count, where the above moving of a data is often called a swap and the erase count stands for the number of times of a corresponding block which has been erased. If a clod data is moved to a block with a higher erase count, the block with a higher erase count will not be updated so often from now on due to the cold data is contained in the block. Once all the blocks containing cold data are processed by the wear leveling, blocks in the non-volatile memory may be more evenly utilized, and accordingly the life of the non-volatile memory is enhanced.

A wear leveling method is disclosed in a United State patent (U.S. Pat. No. 7,035,967 B2). FIG. 3 is a process flow diagram which illustrates an initialization of a wear leveling disclosed in the United State patent (U.S. Pat. No. 7,035,967 B2). The main purpose of the initialization of a wear leveling is to divide all the blocks within a non-volatile memory to a mapping group, a most-frequently-erased group and a least-frequently-erased group, and also to calculate an average erase count of the non-volatile memory.

To start, an initialization request may be received by a memory controller which is in communication with the non-volatile memory in step 302. Such a request may be issued by a user via a host at power up, or issued by the host system under some specific conditions.

Once the initialization request is received, all the erased blocks within the non-volatile memory are identified in step 304. In step 306, N erased blocks with relatively high erase counts out of all the erased blocks are assigned to the most-frequently-erased group. The selection of the N erased blocks with relatively high erase counts can be done through comparing the erase counts of all the erased blocks, where the information about the erase count is stored in the overhead data (OH) as mentioned above. Moreover, the number N can be determined based on the total number of the blocks within the non-volatile memory. Moreover, assigning the N erased blocks with relatively high erase counts to the most-frequently-erased group can be achieved through updating the flash translation layer table (FTL Table).

In step 308, M erased blocks with relatively low erase counts out of all the erased blocks are assigned to the least-frequently-erased group. Similarly, the selection of the M erased blocks with relatively low erase counts can be done through comparing the erase counts of all the erased blocks. Moreover, the number M can be determined based on the total number of the blocks within the non-volatile memory. Moreover, assigning the M erased blocks with relatively low erase counts to the least-frequently-erased group can be achieved through updating the flash translation layer table (FTL Table).

Remaining erased blocks, i.e., erased blocks which have not been assigned to either the most-frequently-erased group or the least-frequently-erased group, are assigned to the mapping group along with the unerased blocks in step 310. In other words, remaining erased blocks as well as blocks containing user data are assigned to the mapping group. It is understood that the erase counts of the erased blocks assigned to the mapping group are in between the erase counts of the erased blocks in the most-frequently-erased group and the least-frequently-erased group.

After all the blocks within the non-volatile memory are assigned to either the most-frequently-erased group, the least-frequently-erased group, or the mapping group, an average erase count of the non-volatile memory is obtained in step 312. The average erase count of the non-volatile memory is obtained through summing the erase counts of individual blocks in the non-volatile memory and dividing the sum by the total number of blocks.

Once the process of the initialization of the wear leveling depicted in FIG. 3 is done, the main process of the wear leveling, for moving a clod data from a block to another block with a relatively high erase count, can be performed.

FIG. 4 is a process flow diagram which illustrates the wear leveling applied to a specific block disclosed in the United State patent (U.S. Pat. No. 7,035,967 B2). To start, select a block (Block-A) containing data from the mapping group in step 402. Then, identify whether the data contained in the block (Block-A) is a cold data in step 404. The determination of the data contained in the block (Block-A) is a cold data can be done through comparing the erase count of the block (Block-A) with the average erase count. In other words, if the erase count of the block (Block-A) is far less than the average erase count, the data contained in the block (Block-A) is seldom to be updated, so as the data contained in the block (Block-A) is identified to a cold data. Alternatively, if the erase count of the block (Block-A) is not far less than the average erase count, the data contained in the block (Block-A) is not seldom to be updated, so as the data contained in the block (Block-A) is most likely not a cold data. If the data contained in the block (Block-A) is a cold data, select a block (Block-B) from the most-frequently-erased group in step 406. Typically, block (Block-B) is the block with the highest erase count in the most-frequently-erased group. Once the block (Block-B) is selected, copy the data contained in the block (Block-A) into the block (Block-B) in step 408. It is understood that copying the data from block (Block-A) into block (Block-B) means copying the user data contained in block (Block-A) into block (Block-B). Once the data contained in the block (Block-A) is copied into the block (Block-B), the block (Block-A) is then erased; accordingly the erase count of the block (Block-A) is increased by one in step 410.

Select a block (Block-C) from the least-frequently-erased group and move the block (Block-C) into the most-frequently-erased group in step 412. Typically, block (Block-C) is the block with the highest erase count in the least-frequently-erased group. Moreover, such move of block (Block-C) allows a space in the least-frequently-erased group to effectively be opened up to the block (Block-A). Then, move the block (Block-A) from the mapping group into the least-frequently-erased group in step 414. Afterwards, move the block (Block-B) to the mapping group in step 416 due to the block (Block-B) now is contained with a cold data.

Via the process of the wear leveling depicted in FIG. 4, the cold data originally contained in the block (Block-A) which originally has a fewer erase count is copied into the block (Block-B), so as the block (Block-A) can be erased later, and accordingly the utility rate of the block (Block-A) is increased. Moreover, because the cold data is copied into the block (Block-B) which originally has a higher erase count, the erase count of the block (Block-B) is then efficiently controlled after the block (Block-B) is containing the cold data. Moreover, as mentioned above, the move of the block (Block-A) from the mapping group into the least-frequently-erased group, the move of the block (Block-B) from the most-frequently-erased group into the mapping group, and the move of the block (Block-C) from the least-frequently-erased group into the most-frequently-erased group can be done through updating the flash translation layer table (FTL Table).

Once all the blocks containing cold data are processed by the wear leveling depicted in FIG. 4, the wear leveling of the non-volatile memory is done, so as the blocks within the non-volatile memory are more evenly utilized.

### SUMMARY OF THE INVENTION

The known wear leveling method uses the erase count as an indication for evenly utilizing the non-volatile memory. The present invention uses another parameter as the indication for the wear leveling method.

Therefore, the present invention relates to wear leveling method adopting a history number, which stands for an absolute time of a block has been written recently, as a main indication.

The present invention provides a wear leveling method, applied to a non-volatile memory containing a plurality of blocks, comprising steps of: assigning the blocks to either a first group, a second group, or a third group according to the corresponding history numbers and data stored in the blocks, wherein the history number indicates an absolute time of writing data into the corresponding block, the first group contains N erased blocks with relatively high history numbers, the second group contains M erased blocks with relatively low history numbers, and the third group contains the remaining blocks not either assigned to the first group or the second group; calculating an average history number of the non-volatile memory; selecting a first block containing a clod data from the third group; selecting a second block from the first group; copying the cold data from the first block into the second block, and updating the history number of the second block according to the absolute time of writing the cold data into the second block; and erasing the first block.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a general host system which includes a non-volatile memory device;

FIG. 2 schematically illustrates a structure of a non-volatile memory device;

FIG. 3 is a process flow diagram which illustrates an initialization of a wear leveling disclosed in the United State patent (U.S. Pat. No. 7,035,967 B2);

FIG. 4 is a process flow diagram which illustrates a wear leveling disclosed in the United State patent (U.S. Pat. No. 7,035,967 B2);

FIG. 5 is a process flow diagram which illustrates an initialization of a wear leveling of the present invention; and

FIG. 6 is a process flow diagram which illustrates a wear leveling of the present invention.

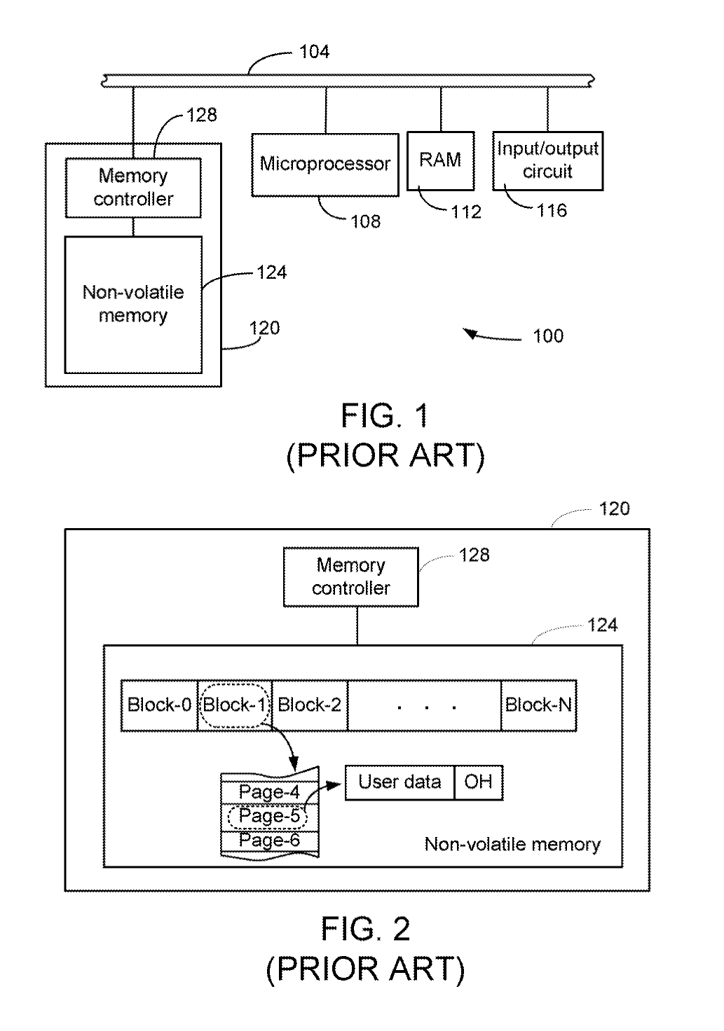

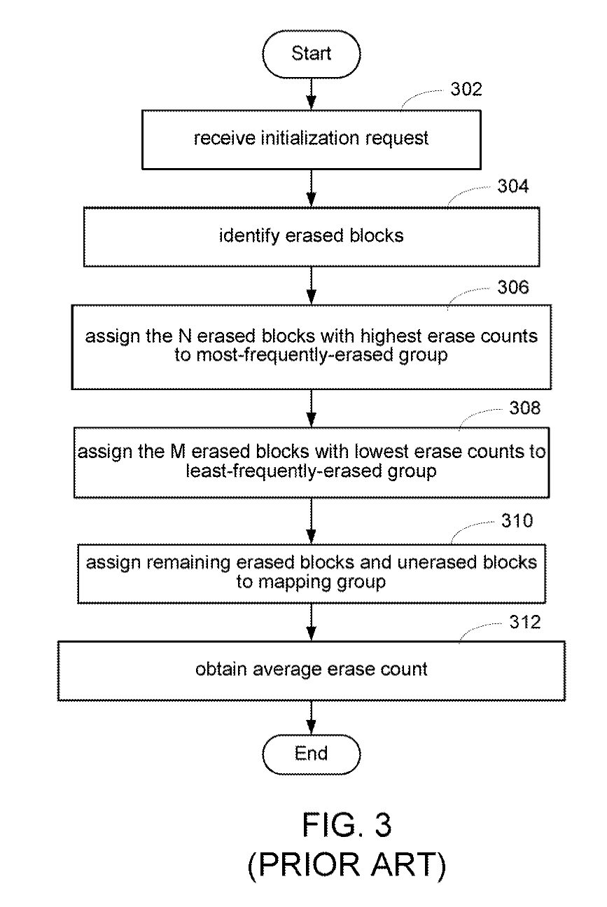

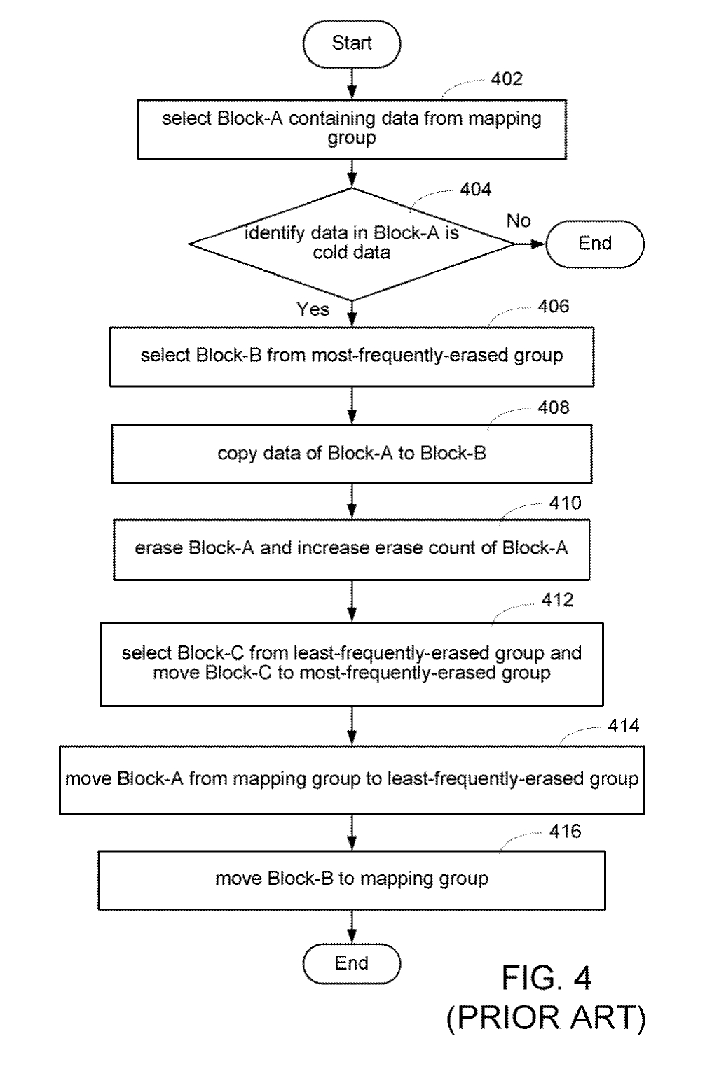

### DETAILED DESCRIPTION OF PREFERRED EMBODIMENTS

Instead of adopting the erase count as the main indication in the conventional wear leveling methods, the wear leveling method of the present invention adopts a history number as a main indication.

Generally, in a host system including a non-volatile memory device, there is a parameter for recording an absolute time of a block last time has been written. The absolute time is counted initially from the first-time powered up of the host system and increased by one every two minutes. For example, if a data is written into a block at a first absolute time after the first-time powered up of the host system, the first absolute time is recorded by the host system and regarded as the history number of the corresponding block. If another data is written into the same block at a second absolute time after the first absolute time, the second absolute time is recorded by the host system and the history number of the corresponding block is updated to the second absolute time.

Obviously, if the history number of a block is far less than an average history number of all the blocks within a non-volatile memory, the last time of the block has been written data is relatively far away from now, so as the data contained in the block has not been updated for a relatively long time, accordingly the data contained in the block is most likely a cold data. Alternatively, if the history number of a block is far higher than an average history number of all the blocks within a non-volatile memory, the last time of the block has been written data is relatively near now, so as the data contained in the block has been updated recently, accordingly the data contained in the block is most likely a hot data. Therefore, based on the characteristic of the history number, the history number is adopted as a main indication in the wear leveling method of the present invention. That is, cold data is moved to a block with a relatively high history number in the wear leveling method of the present invention, so as the blocks within the non-volatile memory are more evenly utilized.

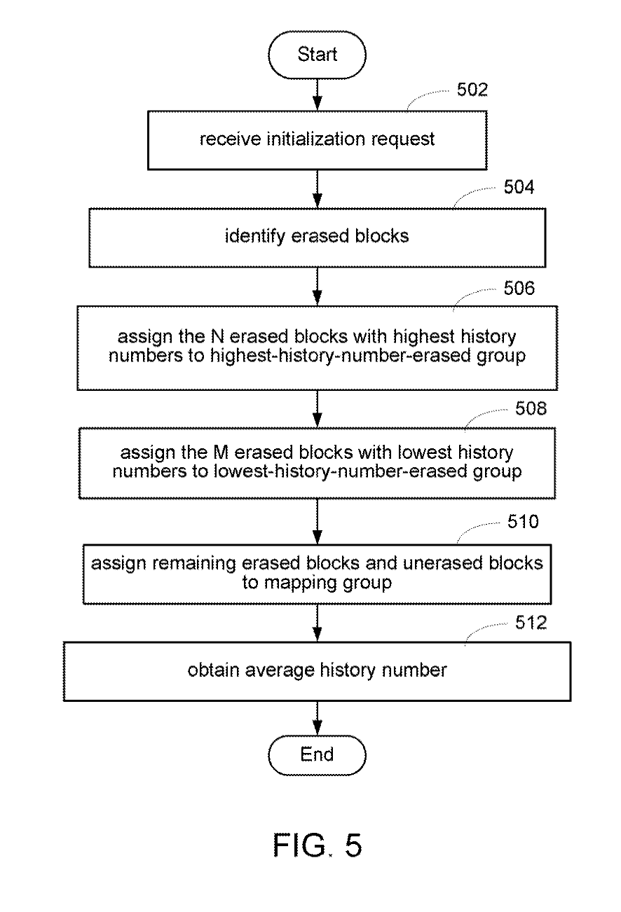

FIG. 5 is a process flow diagram which illustrates an initialization of a wear leveling of the present invention. The main purpose of the initialization of a wear leveling is to divide all the blocks within a non-volatile memory to a mapping group, a highest-history-number-erased group and a lowest-history-number-erased group, and also to calculate an average history number of the non-volatile memory.

To start, an initialization request may be received by a memory controller which is in communication with the non-volatile memory in step 502. Such a request may be issued by a user via a host at power up, or issued by the host system under some specific conditions.

Once the initialization request is received, all the erased blocks within the non-volatile memory are identified in step 504. In step 506, through comparing the history numbers of all the blocks with a predefined high history number, assign N erased blocks with relatively high history numbers out of all the erased blocks to the highest-history-number-erased group. Moreover, the number N can be determined based on the total number of the blocks within the non-volatile memory. Moreover, assigning the N erased blocks with relatively high history numbers to the highest-history-number-erased group can be achieved through updating the flash translation layer table (FTL Table).

In step 508, through comparing the history numbers of all the blocks with a predefined low history number, assign M erased blocks with relatively low history numbers out of all the erased blocks to the lowest-history-number-erased group. Similarly, the number M can be determined based on the total number of the blocks within the non-volatile memory. Moreover, assigning the M erased blocks with relatively low history numbers to the lowest-history-number-erased group can be achieved through updating the flash translation layer table (FTL Table).

Remaining erased blocks, i.e., erased blocks which have not been assigned to either the highest-history-number-erased group or the lowest-history-number-erased group, are assigned to the mapping group along with the unerased blocks in step 510. In other words, remaining erased blocks as well as blocks containing user data are assigned to the mapping group. It is understood that the history numbers of the erased blocks assigned to the mapping group are in between the history numbers of the erased blocks in the highest-history-number-erased group and the lowest-history-number-erased group.

After all the blocks within the non-volatile memory are assigned to either the highest-history-number-erased group, the lowest-history-number-erased group, or the mapping group, an average history number of the non-volatile memory is obtained in step 512. The average history number of the non-volatile memory is obtained through summing the history numbers of individual blocks in the non-volatile memory and dividing the sum by the total number of blocks.

Once the process of the initialization of the wear leveling depicted in FIG. 5 is done, the main process of the wear leveling, for moving a clod data from a block to another block with a relatively high history number, can be performed.

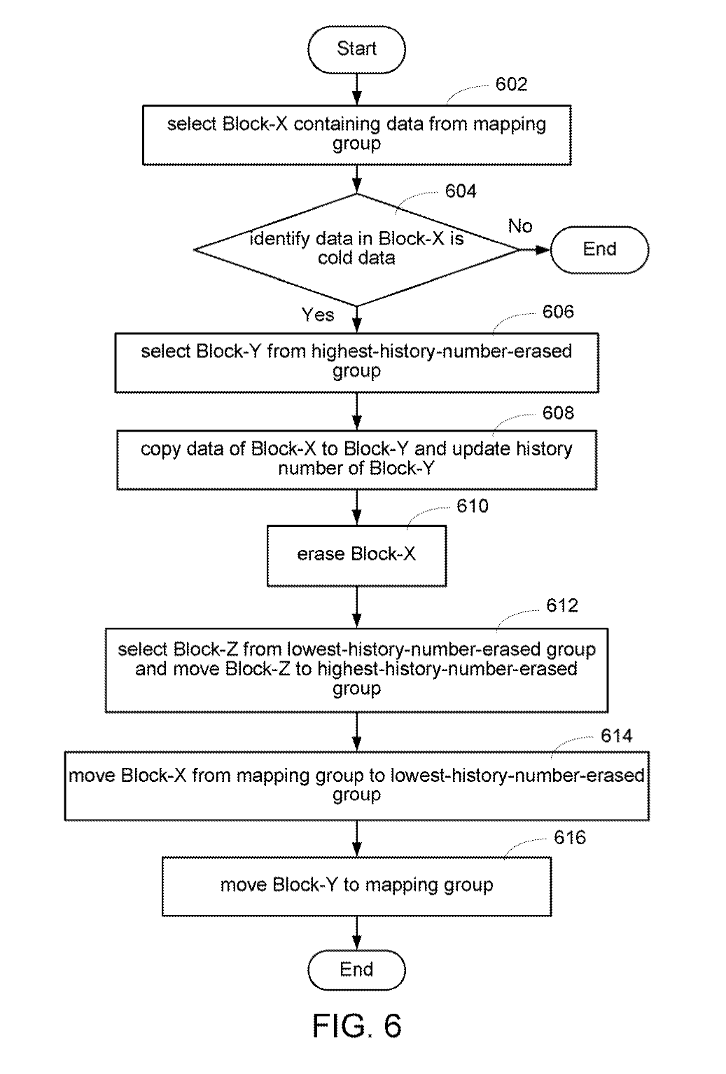

FIG. 6 is a process flow diagram which illustrates the wear leveling method of the present invention applied to a specific block. To start, select a block (Block-X) containing data from the mapping group in step 602. Then, identify whether the data contained in the block (Block-X) is a cold data in step 604. The determination of the data contained in the block (Block-X) is a cold data can be done through comparing the history number of the block (Block-X) with the average history number. That is, if the history number of the block (Block-X) is far less than the average history number of the non-volatile memory, the data contained in the block (Block-X) is most likely a cold data. Alternatively, if the history number of the block (Block-X) is not far less than the average history number of the non-volatile memory, the data contained in the block (Block-X) is most likely not a cold data. If the data contained in the block (Block-X) is a cold data, select a block (Block-Y) from the highest-history-number-erased group in step 606. Typically, block (Block-Y) is the block with the highest history number in the highest-history-number-erased group. Once the block (Block-Y) is selected, copy the data contained in the block (Block-X) into the block (Block-Y), and update the history number of the block (Block-Y) based on the absolute time of writing the cold data to the block (Block-Y) in step 608. It is understood that copying the data from block (Block-X) into block (Block-Y) means copying the user data contained in block (Block-X) into block (Block-Y). Once the cold data originally contained in the block (Block-X) is copied into the block (Block-Y), the block (Block-X) is then erased in step 610.

Select a block (Block-Z) from the lowest-history-number-erased group and move the block (Block-Z) into the highest-history-number-erased group in step 612. Typically, block (Block-Z) is the block with the highest history number in the lowest-history-number-erased group. Moreover, such a move of block (Block-Z) allows a space in the lowest-history-number-erased group to effectively be opened up to the block (Block-X). Then, move the block (Block-X) from the mapping group into the lowest-history-number-erased group in step 614. Afterwards, move the block (Block-Y) to the mapping group in step 616 due to the block (Block-Y) now is contained with a cold data.

Via the process of the wear leveling depicted in FIG. 6, the cold data originally contained in the block (Block-X) which originally has a fewer history number is copied into the block (Block-Y), so as the block (Block-X) can be erased later, and accordingly the utility rate of the block (Block-X) is increased. Moreover, because the cold data is copied into the block (Block-Y) which originally has a higher history number, the data contained in the block (Block-Y) is turned to a hot data. Because the block (Block-Y) is containing a hot data now, the data contained in the block (Block-Y) will not be moved until any erased block has a history number higher than that of the block (Block-Y), so as the history number of the block (Block-Y) is then efficiently controlled. Moreover, as mentioned above, the move of the block (Block-X) from the mapping group into the lowest-history-number-erased group, the move of the block (Block-Y) from the highest-history-number-erased group into the mapping group, and the move of the block (Block-Z) from the lowest-history-number-erased group into the highest-history-number-erased group can be done through updating the flash translation layer table (FTL Table).

Once all the blocks containing cold data are processed by the wear leveling of the present invention, the wear leveling of the non-volatile memory is done, so as the blocks within the non-volatile memory are more evenly utilized.

In the embodiment, categorizing blocks to either the mapping group, the highest-history-number-erased group, or the lowest-history-number-erased group is based on comparing the history numbers of all blocks with the predefined high history number and the predefined low history number. However, blocks within a non-volatile memory can be categorized more than these three groups if necessary. The process of wear leveling method based on more than three groups is similar to the wear leveling method described above and the detail is not given here.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wear leveling method, applied to a non-volatile memory containing a plurality of blocks, comprising steps of:
assigning the blocks to either a first group, a second group, or a third group according to the corresponding history numbers and data stored in the blocks, wherein the history number indicates an absolute time of writing data into the corresponding block, the first group contains N erased blocks with relatively high history numbers, the second group contains M erased blocks with relatively low history numbers, and the third group contains the remaining blocks not either assigned to the first group or the second group;
calculating an average history number of the non-volatile memory;
selecting a first block containing a clod data from the third group;
selecting a second block from the first group;
copying the cold data from the first block into the second block, and updating the history number of the second block according to the absolute time of writing the cold data into the second block; and
erasing the first block.

2. The wear leveling method according to claim 1 further comprising steps of:
selecting a third block from the second group and moving the third block into the first group;
moving the first block from the third group into the second group; and
moving the second block from the first group into the third group.

3. The wear leveling method according to claim 2 wherein the third block is the block with the highest history number in the second group.

4. The wear leveling method according to claim 1 wherein the second block is the block with the highest history number in the first group.

5. The wear leveling method according to claim 1 wherein assigning any block to the first, the second, or the third groups is achieved through updating a flash translation layer table of the non-volatile memory.

6. The wear leveling method according to claim 1 wherein the absolute time is the last time of writing data into the corresponding block.

7. The wear leveling method according to claim 6 wherein the absolute time is counted beginning from the first-powered up time of a host system containing the non-volatile memory.

8. The wear leveling method according to claim 1 wherein the average history number is obtained by summing the history numbers of the plurality of blocks within the non-volatile memory and dividing the sum by the total number of the plurality of blocks within the non-volatile memory.

9. The wear leveling method according to claim 1 wherein the cold data is determined by comparing the history number of the first block with the average history number.

10. The wear leveling method according to claim 9 wherein the clod data is determined if the history number of the first block is less than the average history number.

11. The wear leveling method according to claim 1 wherein the wear leveling method can be performed by a user or automatically performed by a host system containing the non-volatile memory under a specific condition.

12. The wear leveling method according to claim 1 further comprising a step of:
assigning each of the plurality of block to either a first group, a second group, or a third group according to two different predefined history numbers.
